(19) United States
(12) Patent Application Publication
(10) Pub. No.: US 2012/0063081 A1
(43) Pub. Date: Mar. 15, 2012

(54) DOCKING STATION FOR A VIDEO MONITOR

(75) Inventor: Brad Neil GRUNWALD, Garland, TX (US)

(73) Assignee: BE AEROSPACE, INC., Wellington, FL (US)

(21) Appl. No.: 13/231,309

(22) Filed: Sep. 13, 2011

Related U.S. Application Data
(60) Provisional application No. 61/382,144, filed on Sep. 13, 2010.

(51) Int. Cl. G06F 1/16

(52) U.S. Cl. 361/679.41

(57) ABSTRACT

A docking station for a video monitor including a base plate adapted to mount to a seat back, spaced-apart shafts rotatably mounted on the base plate including spaced apart hooks for engaging catches of the video monitor, a biasing member biasing the hooks toward a latching direction, alignment posts extending from the base plate for aligning the video monitor relative to the base plate, and an electrical connector mounted to the base plate for mating with an electrical connector of the video monitor to provide power and signals to the monitor.

### CROSS-REFERENCE TO RELATED APPLICATION

This application claims priority to U.S. Application No. 61/382,144 filed Sep. 13, 2010, the contents of which is incorporated by reference herein in its entirety.

### BACKGROUND

Aircraft passenger seats commonly serve as mounting locations for a variety of accessories including seat controls, audio-visual controls, tray tables and video monitors, among others. Video monitors, in particular, are commonly mounted to a seat back such that the monitor is accessible and visible to a passenger seated behind the monitor.

Conventional methods for mounting video monitors to seat backs include bezel surrounds and complex brackets. Such structures do not allow for removal of the monitor without great effort and/or partial disassembly of the seat back. Further, conventional brackets often disadvantageously requires multiple, independently actuated mechanical fasteners for monitor attachment, and do not adequately conceal the fasteners from passengers, leaving the monitor with an unsatisfactory appearance and susceptible to tampering and theft.

Accordingly, to overcome the disadvantages of conventional designs, provided herein is an embodiment of a seat back docking station for an in-flight monitor that includes concealed latches and access to the latches that allow for rapid removal of the attached monitor with minimal effort, among other features.

### BRIEF SUMMARY

In a first embodiment, a docking station for a video monitor is provided including a base plate adapted to mount to a supporting surface such as a seat back, spaced-apart shafts rotatably mounted on the base plate, each of the shafts including spaced apart hooks for engaging catches of the video monitor, alignment posts extending from the base plate for aligning the video monitor relative to the base plate, and an electrical connector mounted to the base plate for mating with an electrical connector of the video monitor to provide power and signals to the video monitor when the video monitor is engaged in the docking station.

In one aspect, the docking station of the first embodiment may include a biasing member biasing each shaft and its hooks toward a latching direction in which the hooks latch with catches on the backside of the video monitor. The biasing member may be a torsion spring and the hooks may be spring-loaded.

In another aspect, each shaft may define a non-circular recess in an end of the shaft for receiving a tool for rotating the shaft. The recess may be defined in a lower end of the shaft when the shaft is oriented generally vertically such that the tool can be inserted from below and turned to rotate the shaft. The recess and tool may have any complementary shapes to permit non-slipping engagement therebetween.

In another aspect, each alignment post can include a post, a washer and a coil spring captured on the post by the washer. A portion of the post can be received in an opening in the back of the monitor. The coils springs on the posts can be compressed as the monitor is pressed onto the docking station and the washers are moved in the direction of the base plate. The compressed coils springs bias the attached monitor in the direction away from the base plate, consequently biasing the monitor in the direction away from the latched hooks of the shafts and preventing the hooks from unintentionally unlatching from the backside of the monitor. The docking station may include four alignment posts, with one post being positioned adjacent each corner of the base plate.

In another aspect, each of the hooks of the shafts may define a cam surface that acts to push the video monitor away from the docking station and disengage the electrical connector from the video monitor as the shafts are rotated and the video monitor is unlatched.

In another aspect, the supporting surface may be an aircraft seat back, a partition wall, a cabinet or another generally vertical surface to which the docking station can be mounted.

In a second embodiment, a docking station for a video monitor can include a base plate adapted to mount to a supporting surface, a shaft rotatably mounted on the base plate including at least one hook for engaging the video monitor, alignment members extending from the base plate for aligning the video monitor relative to the base plate, and an electrical connector mounted to the base plate for mating with an electrical connector of the video monitor to provide power and signals to the video monitor when the video monitor is engaged in the docking station.

In one aspect, the docking station of the second embodiment can include a biasing member biasing the shaft and the at least one hook toward a latching direction in which the at least one hook latches with at least one catch on the backside of the video monitor. The caches on the backside of the monitor can include a ledge in which the hooks snaps over and seats upon. The biasing member can be a torsion spring and the at least one hook can be spring-loaded.

In another aspect, the shaft can define a non-circular recess in at least one end thereof accessible to insert a tool from above, below or from the sides of the docking station to engage within the recess to rotate the shaft to disengage the hook from the backside of the monitor.

In another aspect, each of the alignment members can include a post, a washer and a coil spring captured on the post by the washer. The washer can move to compress the spring as the video monitor is pressed onto the docking station. The compressed springs can bias the video monitor in the direction away from the base plate, such that release of the hooks from the backside of the monitor causes the compressed springs to move the monitor away from the base plate and be removed therefrom.

In another aspect, the docking station of the second embodiment includes two spaced apart shafts each including two spaced apart hooks. Each of the hooks can define a cam surface that, when rotated, acts to push the video monitor away from the docking station and disengage the electrical connector from the video monitor.

In another aspect, the base plate may be mounted generally flush with its supporting surface, such as a seat back, or may be recessed therefrom. The base plate can generally include a rectangular planar plate and may include brackets for attaching the plate to supporting structure.

### BRIEF DESCRIPTION OF THE DRAWINGS

The exemplary embodiments are understood when the following detailed description is read with reference to the accompanying drawings, in which:

FIG. 1 is an environmental view showing an embodiment of the docking station the attached to a seat back supporting surface;

FIG. 2 is a front perspective view of one embodiment of a docking station for a video monitor;

FIG. 3 is a left side elevation view of the docking station of FIG. 2;

FIG. 4 is bottom elevation view of the docking station of FIG. 2;

FIG. 5 is a front perspective view of another embodiment of a docking station for a video monitor;

FIG. 6 is a left side elevation view of the docking station of FIG. 5;

FIG. 7 is a bottom elevation view of the docking station of FIG. 5;

FIG. 8 is a perspective view of a backside of a monitor configured for attachment to the docking station embodiments;

FIG. 9 is a bottom elevation view showing the alignment of a monitor with the docking station;

FIG. 10 is a bottom elevation view illustrating the latching of a monitor with the docking station;

FIG. 11 is a sectional view through the monitor and docking station showing the hooks in their latched position;

FIG. 12 is a sectional view through the monitor and docking station showing latch release; and

FIG. 13 is a sectional view through the monitor and docking station showing a cam feature of the hooks urging the monitor away from the docking station.

### DETAILED DESCRIPTION OF THE EMBODIMENTS

The exemplary embodiments will now be described more fully hereinafter with reference to the accompanying drawings. It is intended, however, that the embodiments may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention.

The docking stations provided herein, in one aspect, function to releasably secure a video monitor, tablet or other monitor to a supporting structure, such as a seat back, partition, wall or other structure, such as within an aircraft cabin. The docking stations releasably secure the video monitor in a way that allows for rapid removal of a monitor without great effort and without complex bracketry and multiple concealed fasteners. Portions of the docking station may be surrounded with bezels or other structure to enhance the visual appearance of the installed assembly. The docking stations, although described with reference to a video monitor having a specific backside configuration, may be readily modified by those skilled in the art to accommodate the backside of any monitor.

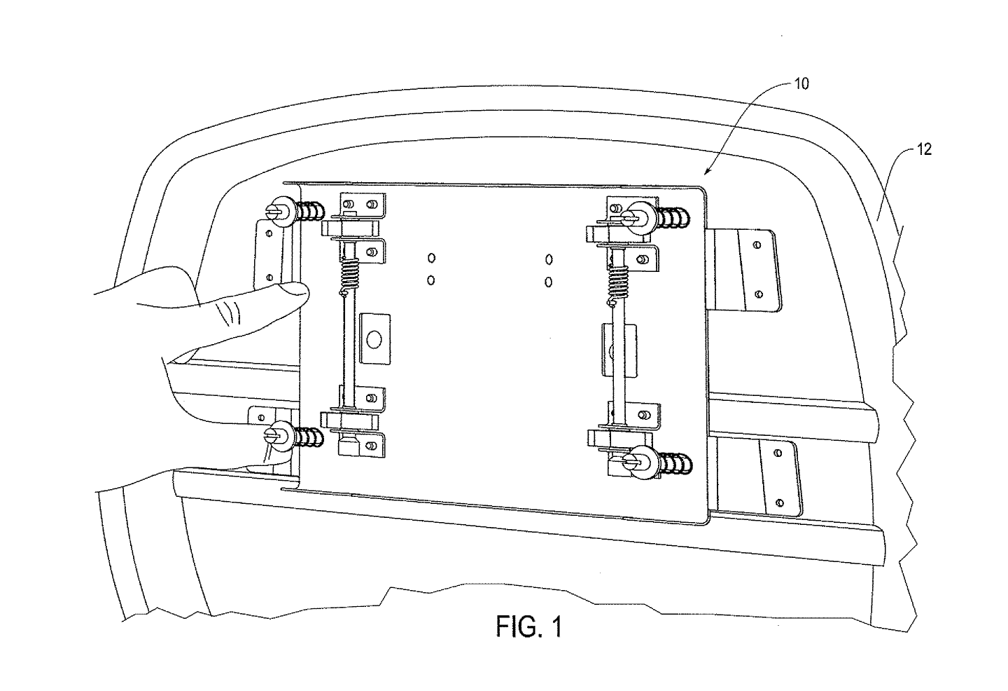

Referring to FIG. 1, a first embodiment of a docking station is shown generally at reference numeral 10. The docking station 10 is shown attached to the upper portion of a seat back 12 such that an attached monitor is accessible and visible to an aft-seated passenger. The docking station 10 may be mounted flush with the seat back or recessed from the surface. The docking station 10 may be mounted to other supporting structure as well.

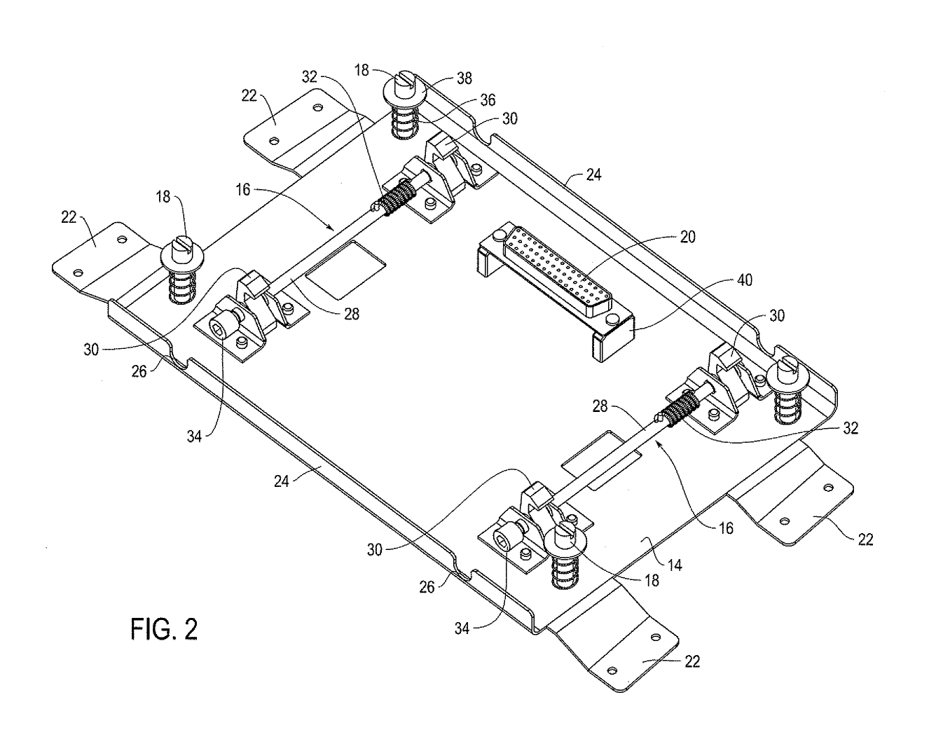

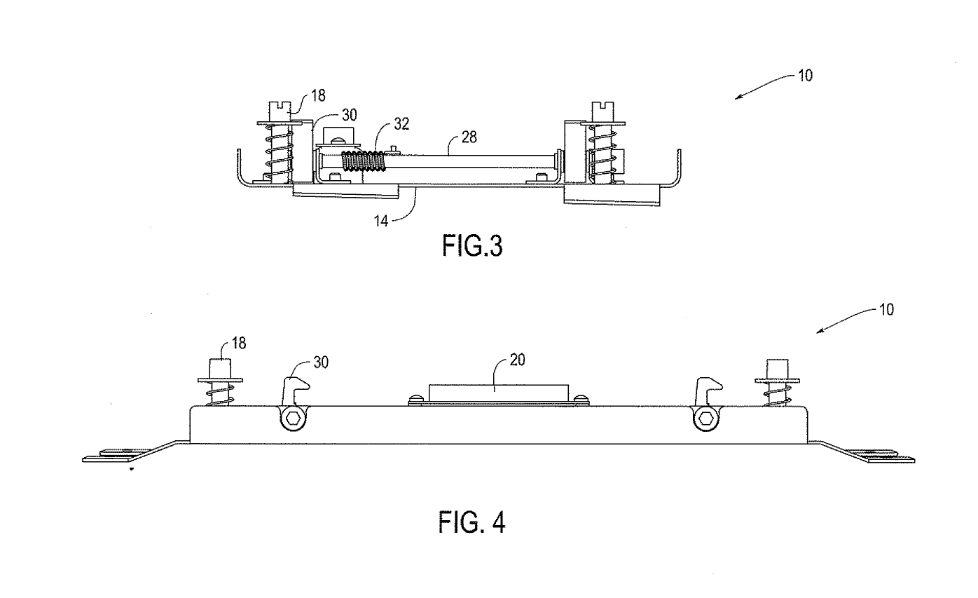

Referring to FIGS. 1-4, the first embodiment of a docking station 10 for a video monitor generally includes a base plate 14, spaced-apart latch assemblies 16, a plurality of alignment posts 18, and a single electrical connector 20 for providing power and signals to a monitor attached to the docking station 10.

As shown, the base plate 14 has a generally rectangular shape that corresponds to the shape of the monitor to be docked, although alternative and non-corresponding base plate shapes and dimensions are envisioned. The base plate 14 is generally planar, and may be constructed by bending a sheet of material, for example aluminum. The base plate 14 includes a plurality of tabs 22 extending laterally from the left and right sides of the base plate 14 that define openings therethrough for receiving fasteners for securing the base plate 14 to seat back structure. The four tabs 22, positioned about the corners of the base plate 14, securely fix the base plate 14 to the seat back and prevent rotation relative to the seat back 12. The base plate 14 further includes top and bottom flanges 24 extending generally perpendicularly (i.e., rearwardly) from the top and bottom edges of the base plate 14, with at least one of the flanges 24 defining spaced-apart gaps 26 along the length thereof that are axially aligned with shafts 28 of the latch assemblies 16 for providing access thereto (see FIG. 4 for example).

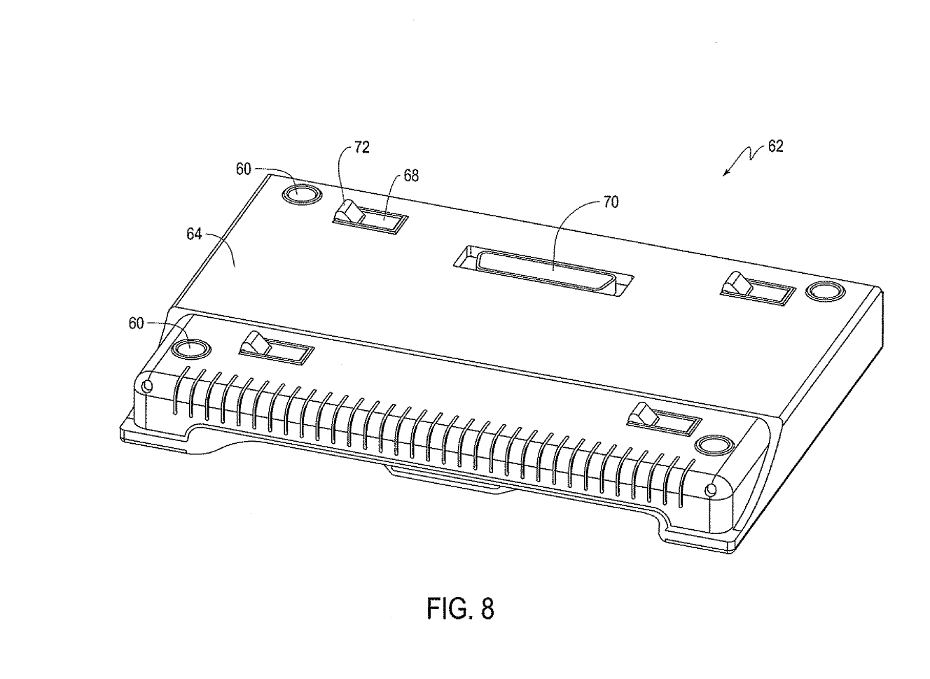

The spaced-apart latch assemblies 16 each include a shaft 28 rotatably mounted on the base plate 14, with each shaft 28 including two spaced-apart hooks 30 fixed in rotation with the shaft 28, for engaging corresponding ledges or “catches” on the backside of the monitor (see FIG. 8 for example). The latch assemblies 16 collectively include four hooks 30 for engaging the monitor to prevent the monitor from being pulled rearwardly from the base plate 14 or rotated relative thereto. Lower ends of the shafts 28 include a hex-shaped or other non-circular recess 34 for use in rotating the shafts 28 with a compatible wrench or tool inserted from “below” the base plate 14 through the gaps 26 defined in the flange 24. The lower ends of the shafts 28 are positioned inwardly from the perimeter of the base plate 14 to conceal them from view and access by a passenger when the monitor is docked. The latch assemblies 16 may be arranged parallel to one another, and in an orientation with respect to the base plate 14 such that they are generally vertical when the base plate is mounted to the seat back. In this arrangement, the lower ends of the shafts 28 are accessible from below the docking station 10.

Torsional springs 32 bias the shafts 28 and hooks 30 toward a latching direction, e.g. to the “right” as shown. The torsional springs 32 are carried on the shafts 28, with one end of the spring fix in rotation to the shaft 28 and the other end secured to or forced against the base plate 14. The hooks 30 are spring-loaded, thus removal of force on the hooks in their unlatching direction (e.g., to the “left”) causes the hooks 30 to move to their latching direction (e.g., to the “right”). The biased state allows the hooks 30 to move to the side as the monitor presses against the hooks to clear the catches on the monitor, and allows the hooks 30 to snap back into place over the catches when clear of the catches.

A plurality of alignment posts 18 (e.g., four as shown) are positioned adjacent the four corners of the base plate 14 and extend rearwardly from the base plate 14 in the direction of the monitor. Each alignment post 18 includes a coil spring 36 captured on the post 18 by a washer 38. The washer 38 seats below the end of the post such that, during docking, a portion of each alignment post 18 is received within an opening in the backside of the monitor to align the monitor with respect to the docking station 10, and the coil springs 36 on the posts 18 are compressed to bias the monitor housing away from the docking station 10 such that the engaged hooks 30 are maintained in firm engagement with the ledges/catches on the back of the housing and the monitor is tightly held on the back of the seat 12. It is envisioned that alternative alignment members may be used to align the monitor with respect to the docking station 10.

The electrical connector 20 is mounted on the base plate 14 and includes a single, multi-pronged connector for mating with a single, multi-pronged electrical connector on the monitor as the monitor is pressed into the docking station 10. The electrical connector may be supported upon posts 40, and the associated wiring may be run through the base plate 14 in the direction of the seat back to be electrically connected to a power supply and signal source. The positioned of the connector 20 is determined by the positioned of the mating connector on the backside of the monitor.

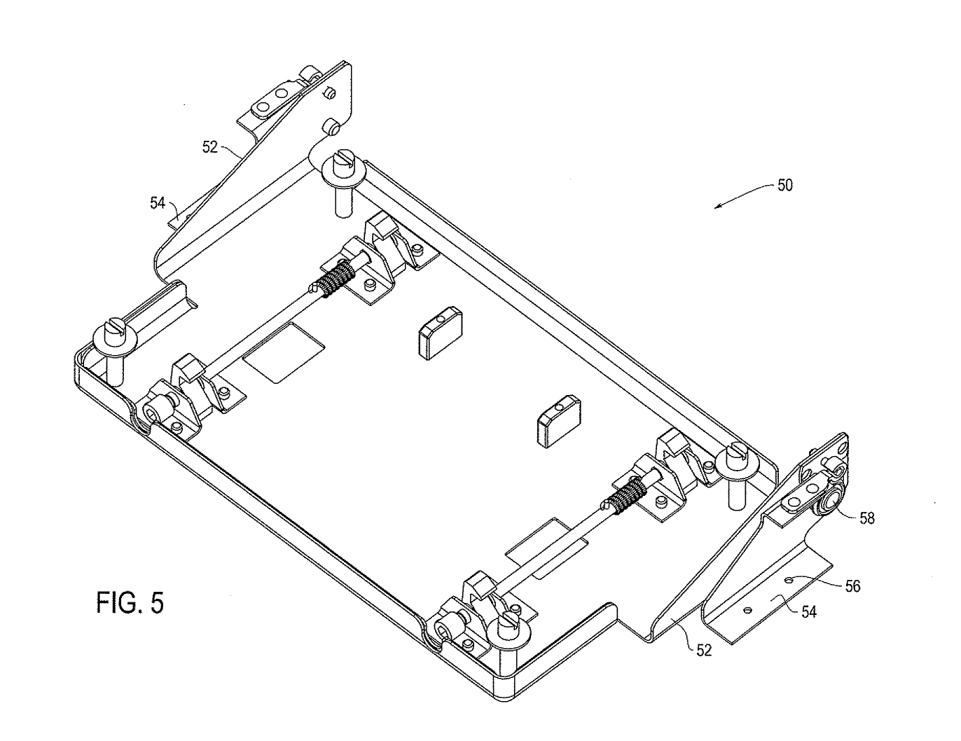

Referring to FIGS. 5-7, a second embodiment of a docking station is shown generally at reference numeral 50. The docking station 50 includes the same latch assemblies 16 and alignment posts 18 of the first embodiment, but includes rearwardly extending side flanges 52 that are pivotably attached to mounting brackets 54 for providing pivoting movement of the base plate 14 relative to the seat back 12, such as to accommodate an angled seat back mounting surface while providing a proper viewing angle and/or to allow adjustment of the viewing angle after installation. Brackets 54 define openings 56 therethrough for receiving conventional fasteners for attaching the docking station to supporting structure.

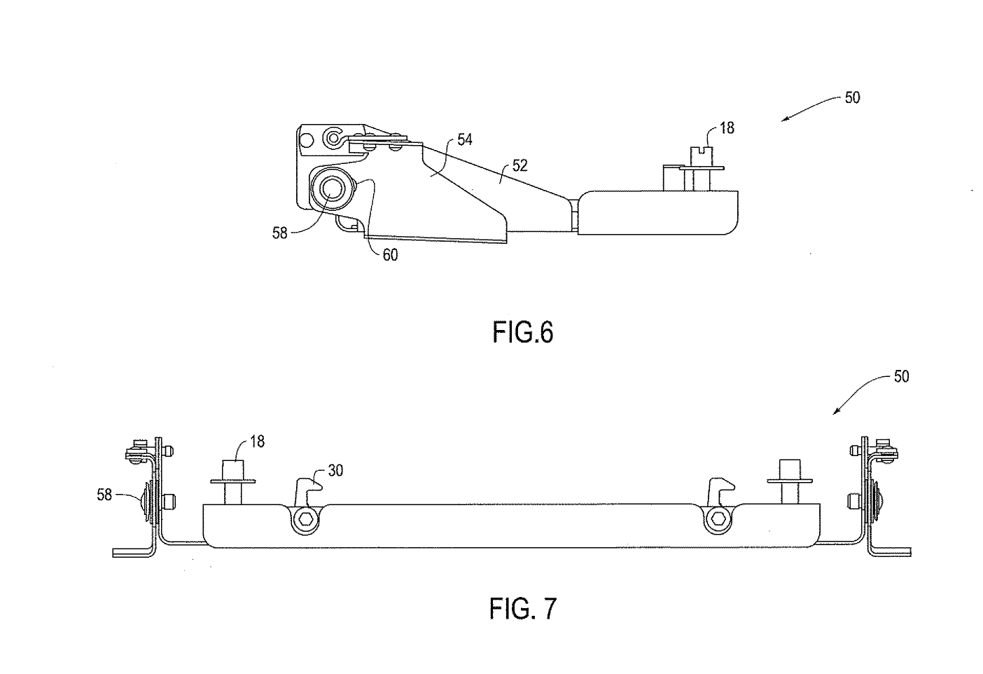

Docking station 50 further includes fixed posts 58 attached to the side flanges 52 and extending laterally therefrom that travel within elongate guide slots 60 defined through the brackets (see FIG. 6 for example). The relationship of the fixed posts 58 and guide slots 60 controls and limits the amount of pivot of the base plate 14 relative to the brackets 54.

Referring to FIG. 8, an exemplary monitor compatible for docking with either docking station 10 or 50 is shown generally at reference numeral 62. The backside of the monitor housing 64 generally includes a plurality of openings 66 that correspond in position with the alignment posts 18 of the docking stations 10, 50. The housing 64 further defines a plurality of recesses 68 that correspond in position with the hooks 30. Each recess 68 includes a clearance for clearing a hook 30, and a ledge or catch 68 for engaging the hook 30. The recesses 68 may define latch lead-ins 72 for guiding the hooks 30 into the recesses. The monitor 62 further includes a single, multi-pronged electrical connector 70 for mating with the docking station electrical connector 20.

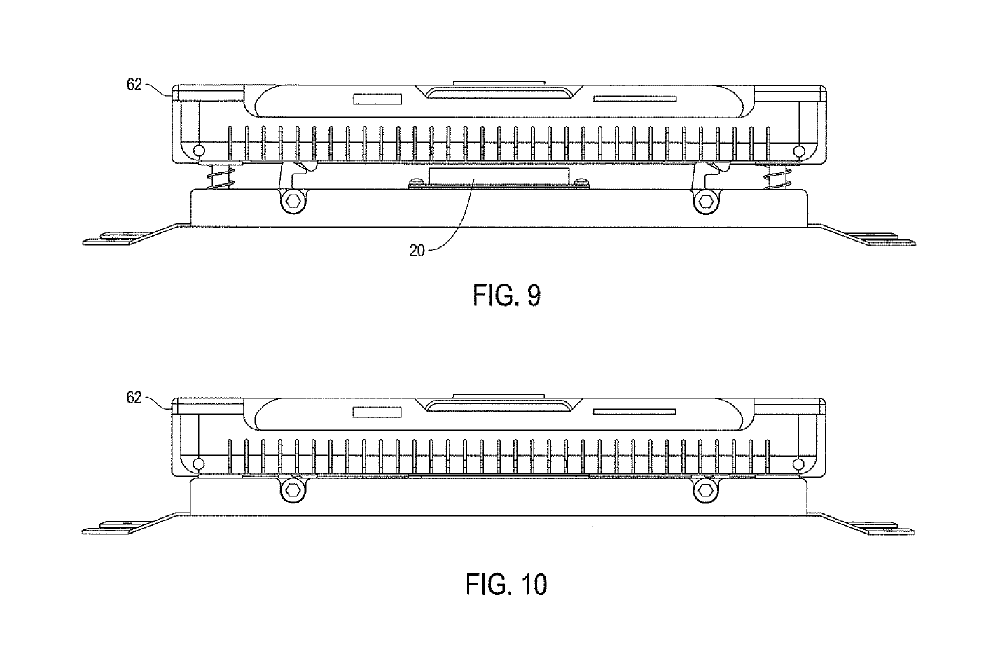

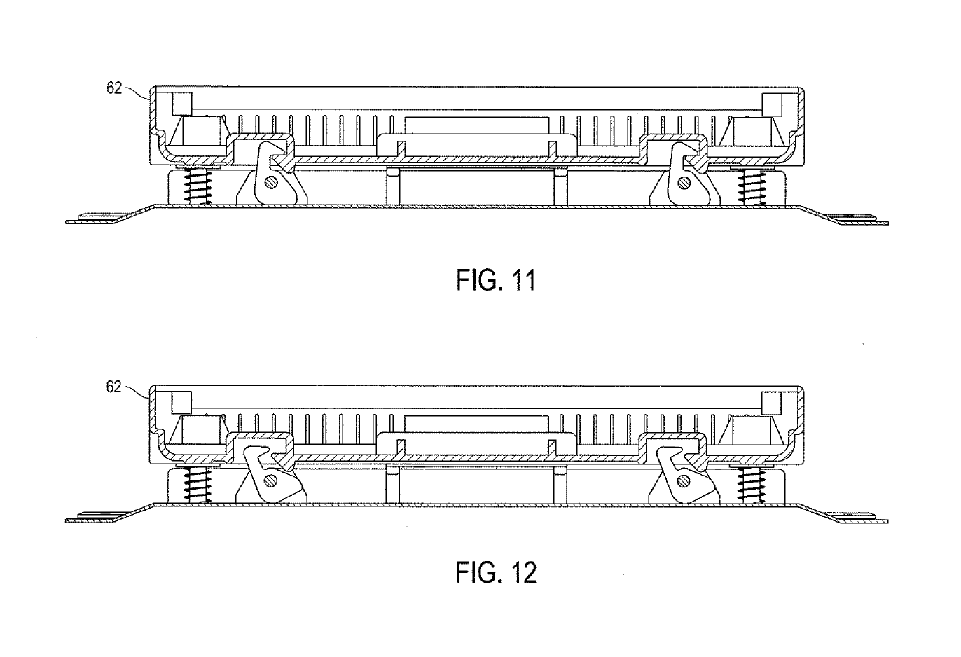

Referring to FIGS. 9-12, the monitor 62 is shown being docked and undocked from the docking station 10 or 50. Referring specifically to FIG. 9, as the monitor 62 is docked, the alignment posts 18 are aligned with and received within the openings 66 in the backside of the monitor housing. Referring specifically to FIGS. 10 and 11, pressing the properly aligned monitor housing 64 toward the docking station 10 causes the spring-loaded hooks 10 to pivot upon engagement with latch lead-ins 72 on the back of the housing 64 until the hooks 30 clear the lead-ins 72 and the torsional springs 32 cause the hooks 30 to snap over the mating ledges/catches 68. At the same time the housing 64 is pressed into the docking station 10, the coil springs 36 on the posts 18 are compressed and maintained in a compressed state such that the engaged hooks 30 are maintained in firm engagement with the ledges/catches 68. The engagement of the hooks 30 with their respective ledge/catch 68 prevents the attached monitor 62 from being pulled rearwardly from the docking station 10.

Referring specifically to FIG. 12, the docked monitor 62 is removed by inserting a tool through the gap 26 from below the hook shafts 28 and rotating the shafts 28 to disengage the hooks 30 from their catches 68. The stored force in the compressed alignment post springs 36 urges the monitor 62 in the direction away from the docking station 10 or 50. The monitor 62 can be pulled from the docking station 10 or 50 when the hooks 30 are clear of their catches 68. After release of the monitor 62, the biased hooks 30 return to their starting position ready to reengage the monitor 62.

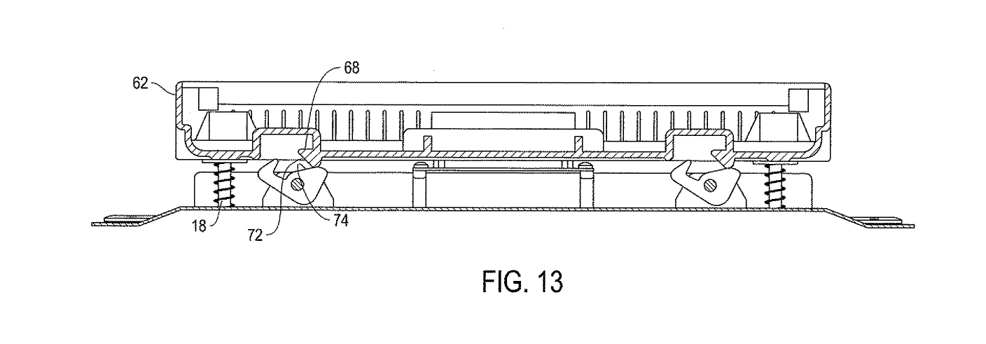

Referring to FIG. 13, the latch assemblies 16 may further include a cam surface 74 defined on each hook body that functions to push against the latch lead-ins 72 as the shafts 28 are rotated, to force the housing 64 away from the docking station 10 and disengage the electrical connector 20.

Although exemplary embodiments of a docking station for an in-flight video monitor have been described and shown herein, it is intended that various modifications by those of routine skill in the art can be made to the docking station without departing from the spirit and scope of this disclosure, and it is intended that any such modifications be encompassed by this disclosure and the claims.

What is claimed is:

1. A docking station for a video monitor, comprising:
a base plate adapted to mount to a supporting surface;
spaced-apart shafts rotatably mounted on the base plate, each of the shafts including spaced apart hooks for engaging catches of the video monitor;
alignment posts extending from the base plate for aligning the video monitor relative to the base plate; and
an electrical connector mounted to the base plate for mating with an electrical connector of the video monitor to provide power and signals to the video monitor when the video monitor is engaged in the docking station.

2. The docking station according claim 1, further comprising a biasing member biasing each shaft and its hooks toward a latching direction in which the hooks latch with catches on the backside of the video monitor.

3. The docking station according to claim 1, wherein the biasing member is a torsion spring and the hooks are spring-loaded.

4. The docking station according to claim 1, wherein each shaft defines a non-circular recess in an end of the shaft for receiving a tool for rotating the shaft.

5. The docking station according to claim 1, wherein each alignment posts includes a post, a washer and a coil spring captured on the post by the washer.

6. The docking station according to claim 1, wherein the alignment posts are positioned adjacent the corners of the base plate and the washer moves to compress the spring of each post as the video monitor is pressed onto the docking station, and wherein the compressed springs of the posts bias the video monitor in the direction away from the base plate.

7. The docking station according to claim 1, wherein each of the hooks defines a cam surface that acts to push the video monitor away from the docking station and disengage the electrical connector from the video monitor as the shafts are rotated and the video monitor is unlatched.

8. The docking station according to claim 1, wherein the supporting surface is an aircraft seat back.

9. A docking station for a video monitor, comprising:
a base plate adapted to mount to a supporting surface;
a shaft rotatably mounted on the base plate including at least one hook for engaging the video monitor;
alignment members extending from the base plate for aligning the video monitor relative to the base plate; and
an electrical connector mounted to the base plate for mating with an electrical connector of the video monitor to provide power and signals to the video monitor when the video monitor is engaged in the docking station.

10. The docking station according claim 9, further comprising a biasing member biasing the shaft and the at least one hook toward a latching direction in which the at least one hook latches with at least one catch on the backside of the video monitor.

11. The docking station according to claim 9, wherein the biasing member is a torsion spring and the at least one hook is spring-loaded.

12. The docking station according to claim 9, wherein the shaft defines a non-circular recess in an end of the shaft for receiving a tool for rotating the shaft.

13. The docking station according to claim 9, wherein the shaft is oriented substantially vertically and the recess is defined in a lower end of the shaft.

14. The docking station according to claim 9, wherein each of the alignment members includes a post, a washer and a coil spring captured on the post by the washer.

15. The docking station according to claim 14, wherein the posts are positioned adjacent the corners of the base plate and the washer moves to compress the spring of each post as the video monitor is pressed onto the docking station, and wherein the compressed springs of the posts bias the video monitor in the direction away from the base plate.

16. The docking station according to claim 9, further comprising spaced apart shafts each including spaced apart hooks.

17. The docking station according to claim 16, wherein the hooks each define a cam surface that acts to push the video monitor away from the docking station and disengage the electrical connector from the video monitor as the shafts are rotated and the video monitor is unlatched.

18. A docking station for a video monitor, comprising:
a base plate adapted to mount to a seat back;
spaced-apart shafts rotatably mounted on the base plate, each of the shafts including spaced apart hooks for engaging catches of the video monitor;
a biasing member biasing each shaft and its hooks toward a latching direction;
alignment posts extending from the base plate for aligning the video monitor relative to the base plate; and
an electrical connector mounted to the base plate for mating with an electrical connector of the video monitor to provide power and signals to the video monitor when the video monitor is engaged in the docking station.
